(19) United States
(12) Patent Application Publication
(10) Pub. No.: US 2003/0031784 A1
(43) Pub. Date: Feb. 13, 2003

(54) Method for collecting and encapsulating fine particles

(76) Inventor: Michel Perrut, Nancy (FR)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 10/169,118

(22) PCT Filed: Jan. 5, 2001
(86) PCT No.: PCT/FR01/00030

(30) Foreign Application Priority Data
Jan. 7, 2000 (FR) 00/00185

(51) Int. Cl. B05D 7/00

(52) U.S. Cl. 427/212; 427/213.3; 118/400

(57) ABSTRACT

The invention concerns a method for collecting and encapsulating with a coating agent particles dispersed in a fluid at supercritical pressure and an installation for implementing said method. Said method is characterised in that it comprises steps which consist in: expanding said fluid at a pressure less than its critical pressure, so as to bring it to a gaseous state; causing said gas to trickle down in a liquid consisting of a solution substantially saturated with the coating agent in a solvent in which the particles are insoluble, so as to exact at least partially the solvent; and causing the coating agent to precipitate onto the particles thereby forming microcapsules.

The present invention relates to a method for collecting and encapsulating solid fine particles, generated by a method employing a fluid at supercritical pressure, as well as to an installation for carrying out this method.

It is known that numerous industries use solids in pulverulent form, in the form of complex particles comprising a core made of a certain material and a coating made of a different material. For example, this type of solids, which are designated microcapsules when their diameter is less than about 100 μm, is used when an active product must be protected from the environment during conservation or use thereof.

Such microcapsules are for example used in particular in reproduction graphics inks, in numerous cosmetic and dermatological preparations, and in pharmaceutical products. In effect, the pharmaceutical industry, but also the cosmetics industry, requires novel galenic forms in order to improve the efficiency of certain molecules of therapeutic or dermatological interest. In particular, it is seeking the means for effecting an efficient protection of certain molecules which would be destroyed as soon as they are absorbed by the digestive enzymes, or which would not be stable for conservation in the presence of oxygen, humidity of the air, or light.

Furthermore, it is sometimes advantageous to obtain a slow dissolution within the tissues or biological fluids such as the blood or the lymph. In order to make such microcapsules, the particles of active ingredient are coated with a suitable coating, as tight as possible with respect to the degradation agents, but which allows an appropriate diffusion of this active ingredient at the desired place.

It will be noted that these microcapsules are significantly different from other complex particles, commonly called micro-spheres, which are constituted by a raw material dispersed within another matter but which, unlike the microcapsules, are not structured as a core and a continuous coating; for example the raw material may be partly in contact with the outside. It will be understood that this results in very different properties for these two types of particles, in particular concerning the possible interaction of the raw material with the environment of the particles.

Supercritical fluids, and particularly supercritical carbon dioxide, are widely used for making very fine powders capable of dissolving very rapidly or which may be used by ingestion by the respiratory tracts. The supercritical fluids are also studied with a view to obtaining complex particles formed by mixtures of different morphologies of the active principle and of an excipient, such as micro-spheres or microcapsules.

By numerous Patents and scientific publications, it is known that microparticles can be obtained, with a granulometry generally included between 1 μm and 10 μm, and nanoparticles, with a granulometry generally included between 0.1 μm and 1 μm, using methods employing supercritical fluids, such as the method known under the designation RESS, which consists in expanding very rapidly at low pressure a solution of a product to be atomized in a supercritical fluid, or the so-called anti-solvent method known under the designations SAS, SEDS, PCA, ASES, which consists in pulverizing a solution of the product to be atomized in an organic or aqueous solvent within a stream of fluid in supercritical state.

These methods make it possible to obtain very fine particles dispersed within a gaseous stream at low pressure (RESS method) or at high pressure (SAS method). The collection of these fine particles is a very delicate operation, especially when it is desired that productions be large-scale. French Patents Nos. 99 15832 and 99 15834 have proposed methods for producing, on an industrial scale, extremely fine powders bereft of any form of granulate.

On a laboratory scale, the generated particles are captured by filtration on a filtering member, woven or non-woven, generally disposed at the bottom of the recipient where the particles are generated. The recovery of the particle-laden filtering member and the collection of the particles therefore necessitate the complete depressurization of this recipient, its opening and manual manipulation of this element. This procedure is not compatible with the requirements of hygiene and of safety in force in the pharmaceutical industry, as a part of the fine particles is found in the atmosphere with the risks of inhalation by the personnel present, and the contamination of the medicament thus atomized is also to be feared. Finally, it is obvious that such a procedure is expensive and hardly adapted to extrapolation on a large scale.

The formation of microspheres has been described in several Patents and publications in accordance with techniques employing a supercritical fluid, such as the RESS technique (Debenedetti P., Journal of Controlled Release, 24, 1953, pages 27-44—Debenedetti P., Journal of Supercritical Fluids, 7, 1994, pages 9-29) or anti-solvent technique (Patents EP 0542314, EP 0322687, WO 95/01221 and WO 96/00610, Chou and Tomasko, Proceedings of the 4th International Symposium on Supercritical Fluids, Sendai, Japan, 1957, pages 55-57).

Furthermore, Patents EP-0 706 821 and FR-2 753 639 disclose methods aiming at generating microcapsules which employ a fluid at supercritical pressure. The first method is based on the placing of the coating agent in solution in the fluid at supercritical pressure. Now, it is known that the majority of coatings used for making microcapsules are insoluble in such fluids, which considerably limits the practical scope of this method. The second method describes the coacervation of the coating agent initially dissolved in an organic solvent within which the particles to be coated are maintained in dispersion, said coacervation being provoked by an anti-solvent effect caused by the dissolution of the supercritical fluid in said organic solvent, the recovery of the capsules obtained being effected after complete extraction of the organic solvent by a stream of supercritical fluid, then decompression of the recipient in which the encapsulation has been effected. Although the separation of the capsules thus elaborated and of the supercritical fluid is not described, it seems obvious that the smallest capsules, particularly those whose diameter is smaller than 10 μm, will be entrained by the flux of the supercritical fluid and will therefore emerge from the treatment chamber with the stream of fluid. Such a method is therefore not applicable to the elaboration of capsules whose diameter is less than 20 μm.

The present invention has for its object to propose a method for capturing and encapsulating very fine particles, with a diameter less than 10 μm, and generally less than 10 μm, generated by a method employing a supercritical pressure.

It will firstly be recalled what such a supercritical fluid is and what its properties are.

It is known that bodies are generally known in three states, namely solid, liquid or gaseous and one passes from one to the other by varying the temperature and/or the pressure. Now, there exists a point beyond which one can pass from the liquid state to the gas or vapour state without passing through a boiling or, inversely, through a condensation, but continuously: this point is called the critical point.

It is also known that a fluid in supercritical state, i.e. a fluid which is in a state characterized either by a pressure and a temperature respectively higher than the critical pressure and temperature in the case of a pure body, or by a representative point (pressure, temperature) located beyond the envelope of the critical points represented on a diagram (pressure, temperature) in the case of a mixture, presents, for very numerous substances, a high solvent power with no comparison with that observed in this same fluid in the state of compressed gas. The same applies to so-called “subcritical” liquids, i.e. liquids which are in a state characterized either by a pressure higher than the critical pressure and by a temperature lower than the critical temperature in the case of a pure body, or by a pressure greater than the critical pressures and a temperature lower than the critical temperatures of the components in the case of a mixture (cf. the article by Michel PERRUT—Les Techniques de l'Ingenieur (Engineering Techniques) “Extraction by supercritical fluid, J 2 770—1 to 12, 1999”).

The considerable and modulatable variations of the solvent power of the supercritical fluids are, furthermore, used in numerous methods of extraction (solid/fluid), of fractionation (liquid/fluid), of analytical or preparative chromatography, of treatment of materials (ceramics, polymers) and of particle generation. Chemical or biochemical reactions are also made in such solvents. It should be noted that the physico-chemical properties of carbon dioxide as well as its critical parameters (critical pressure: 7.4 MPa and critical temperature: 31° C.) make it the preferred solvent in numerous applications, all the more so as it does not present any toxicity and is available at very low price in very large quantities. Other fluids may also be used under similar conditions, such as nitrogen protoxide, light hydrocarbons having two to four carbon atoms, and certain halogenated hydrocarbons.

It will be also be recalled that the collection of fine particles within a gaseous stream at a pressure close to atmospheric pressure has been effected on a very large scale for a long time during an operation called dedusting. The different dedusting methods and equipment used at the present time are adapted to the size of the particles to be captured:

Inertial devices such as baffles and cyclones, are efficient for capturing particles whose diameter is greater than 10 μm or 20 μm;

Electrostatic devices such as the dedusters used for the treatment of fumes from coal-fired boilers, which are complex apparatus, efficient for capturing very fine particles with a diameter greater than about 1 μm.

Gas washers of different designs which are adapted to capture particles depending on their diameter, the most efficient being Venturi tube washers which makes it possible to capture particles of submicronic diameters.

Filters constituted by woven or non-woven filtering materials which make it possible to capture the finest particles including those whose diameter is included between 0.1 μm and 1 μm.

However, each of these techniques presents limitations depending on the characteristics of the particles to be captured.

In the case of fine particles for pharmaceutical or cosmetic use, it is clear that the inertial devices are not efficient enough and that the electrostatic devices cannot be used for reasons of cost and of safety. There therefore remain only the washers and the filters.

The washers can be employed if it is accepted to collect the particles in the form of a dispersion within a liquid where they are strictly insoluble and either a subsequent separation step is employed or this dispersion is used as such.

The filters also present a notorious drawback, as it must be possible to recover the particles thus collected and to re-use the filter (or possibly destroy it). This is particularly difficult to carry out while respecting the rules imposed in the pharmaceutical industry.

The present invention makes it possible both to capture very fine particles and to ensure encapsulation thereof The present invention thus has for its object a method for capturing and encapsulating with a coating agent particles dispersed in a fluid at supercritical pressure, characterized in that it comprises the steps consisting in:

expanding this fluid at a pressure less than its critical pressure, so as to bring it to a gaseous state;

causing said gas to percolate in a liquid consisting of a solution substantially saturated with the coating agent in a solvent in which the particles are insoluble, so as to extract at least partially the solvent, and causing the coating agent to precipitate onto the particles thereby forming microcapsules.

The concentration of the coating agent in the solvent is preferably sufficient in order that, due to the percolation of the gas in said liquid, the coating agent passes into oversaturation and consequently precipitates on the particles to coat them, such concentration nonetheless being sufficiently low to avoid a precipitation giving rise to the formation of agglomerates.

The solution of coating agent can, of course, be supplied continuously and one continuously draws off, through a filtering material disposed in a recipient for collection under pressure, the quantity of liquid phase present in the chamber being maintained virtually constant until the end of the particle capturing and encapsulating operation, the microcapsules being subsequently recovered after elimination of the residual solvent absorbed thereby, by sweeping by a stream of pure fluid at supercritical pressure and depressurization of the collecting recipient and continuous drawing off.

The encapsulated particles will preferably have a diameter included between 0.01 μm and 20 μm and will in particular by constituted by an active principle of food, pharmaceutical, cosmetic, agrochemical or veterinary interest.

Furthermore, and although another gas can be used, the fluid at supercritical pressure will be carbon dioxide.

It will be noted that the fluid at supercritical pressure laden with organic solvents may be recycled in accordance with the methods conventionally used in supercritical extraction-fractionation, in particular by using devices of the type such as those described in French Patent FR-A-2 584 618 already cited.

A major advantage of the method forming the subject matter of the present invention resides in particular in the fact that the choice of the organic solvent, in which the capturing and encapsulation of the particles take place, is fairly wide. In effect, any solvent in which the active principle constituting the particles is not soluble and where the coating agent is even sparingly soluble, may suit, even if it presents a very high affinity for the fluid at supercritical pressure in which these particles are generated, since this fluid being expanded prior to the percolation within this organic solvent, therefore loses a large part of its solvent power with respect to this organic solvent which it will entrain only at very low concentration, without there being a risk of the organic solvent and this fluid forming a single phase, causing all liquid phase to disappear and thus rendering impossible the controlled generation of the microcapsules and their subsequent recovery as described hereinabove.

Furthermore, the present invention is also advantageous in that it makes it possible to effect an encapsulation by precipitation of the coating agent on particles, by variation of the pH particularly by the dissolution of the gaseous carbon dioxide in an aqueous solution of the coating product.

The present invention also has for an object an installation for capturing and coating fine particles in dispersion within a fluid in the supercritical state, characterized in that it comprises means for expanding the fluid in the supercritical state to take it to the state of gas, a chamber for capturing the particles containing a coating agent in solution in a solvent in which the particles are insoluble, and means for causing said gas to percolate through the solution.

The concentration of the coating agent in the solvent will preferably be sufficient in order that, due to the percolation of the gas in said liquid, the coating agent passes into oversaturation and, consequently, precipitates on the particles to coat them, this concentration being nonetheless sufficiently low to avoid a precipitation giving rise to the formation of agglomerates.

The installation may comprise at least one collecting recipient provided with filtering means, which is in communication with the capturing chamber. The collecting recipient may be in communication with means for supply of fluid at supercritical pressure.

Forms of embodiment of the present invention will be described hereinafter by way of non-limiting example, with reference to the accompanying drawings, in which:

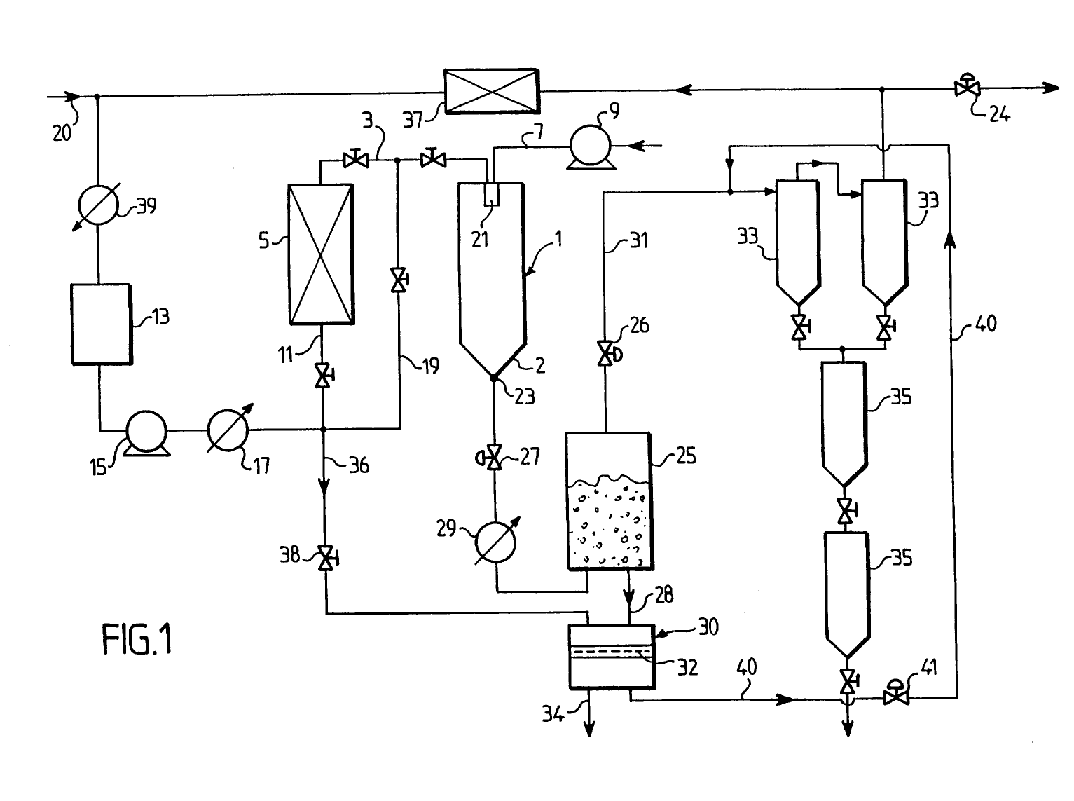

FIG. 1 schematically shows an installation for producing, capturing and encapsulating particles according to the invention.

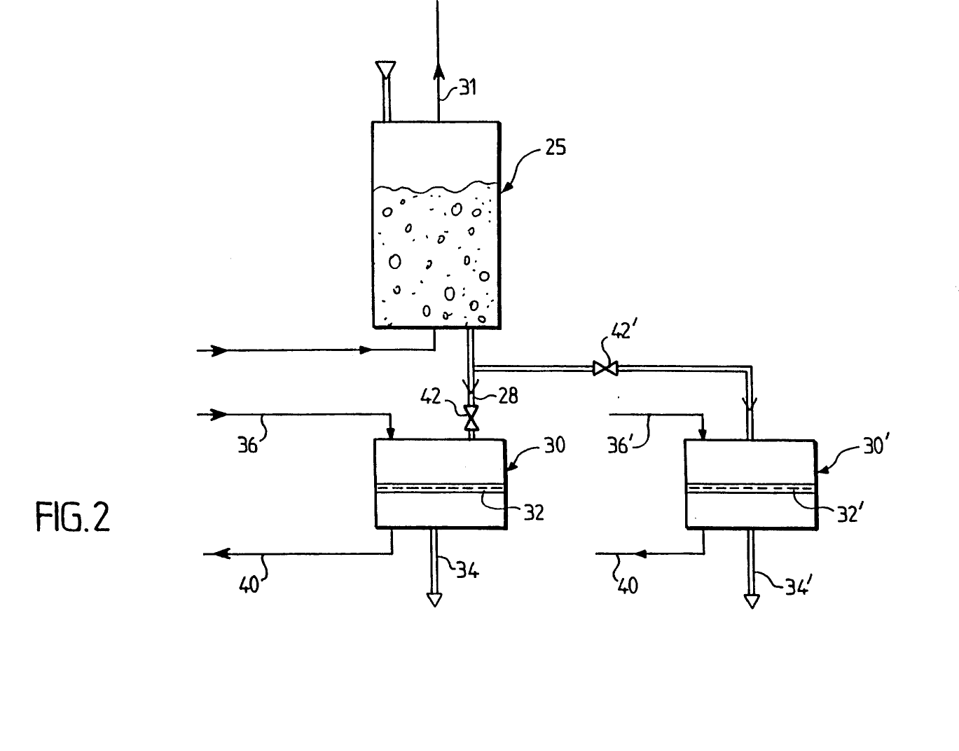

FIG. 2 is a diagram showing a variant embodiment of the invention shown in FIG. 1.

The two examples of embodiment of the invention which are described hereinafter employ an installation shown in FIG. 1 which allows the production of the fine particles by carrying out either the RESS method or the anti-solvent SAS (or SEDS, PCA, ASES . . . ) method, then the capturing and coating thereof This installation is essentially constituted by an atomisation chamber 1 which is connected by a pipe 3 to the upper part, or outlet, of an extractor 5 or, by a pipe 7, to a pump 9 for injection of liquid.

When the particle generation method is of RESS type, the extractor 5 is used, which is in that case supplied at its base through a pipe 11 connected to a reservoir 13 for storing liquefied gas via a diaphragm pump 15 and an exchanger 17 which make it possible to take the liquefied gas to the desired pressure and temperature.

When the particle generation method is of anti-solvent type, the extractor 5 is not used and the fluid issuing from the exchanger 17 is in that case directly supplied to the atomisation chamber 1 through a pipe 19, the solution of the product to be atomized in an organic or aqueous solvent being introduced in the upper part of the atomisation chamber 1 through the pipe 7 and the pump 9.

More precisely, the atomisation chamber 1 is constituted by a tubular recipient of vertical axis which terminates at its base by a conical bottom 2 with cone angle of the order of 45°. This atomisation chamber 1 comprises, at its upper part, an injection nozzle 21 supplied either by the pipe 3 connected to the extractor 5, or by the pipe 7 connected to the pump 9. The lower part of the chamber 1 is provided with an outlet 23 for the fluid at supercritical pressure containing the particles.

The outlet 23 is connected to the base of a capturing and encapsulation chamber 25 via a regulation valve 27 and an exchanger 29. This capturing and encapsulation chamber 25 contains a solution in a solvent, particularly an organic solvent, of the coating agent which it is desired to deposit around the particles. The concentration of the coating agent in the solvent will be sufficient for it to pass into state of oversaturation further to the contact with the gas conveying the particles and precipitates on the latter in order to coat them. However, this concentration will be sufficiently low for this precipitation not to be uncontrolled and anarchic, leading to the formation of agglomerates. The lower part of the capturing and encapsulation chamber 25 is in communication by a pipe 28 with a collecting recipient 30 provided with a filtering element 32. The upper part of the recipient 30 is connected, by a pipe 36, comprising a control valve 38 to the pipe 19 for supplying supercritical carbon dioxide. The base of this recipient 30 comprises drawing-off means 34 and a conduit 40 for recycling the supercritical carbon dioxide provided with a valve 41.

The upper part of the capturing and encapsulation chamber 25 is connected, by a pipe 31, to cyclonic separators 33 and drawing-off elements 35, and is in communication with the storage tank 13 via a adsorbent bed 37 and a condenser 39.

Under these conditions, if the so-called anti-solvent SAS particle generation technique is employed, the product to be atomised is dissolved in a solvent and injected in the atomisation chamber 1 by the diaphragm pump 9 through the nozzle 21, the atomisation chamber 1 being swept by a fluid at supercritical pressure taken to the working pressure by the diaphragm pump 15 and to the working temperature by the heat exchanger 17. At the outlet of the atomisation chamber 1, the fluid laden with particles is expanded in the regulation valve 27, heated in the exchanger 29, then is injected into the capturing and encapsulation chamber 25 where it percolates the liquid phase contained therein. In the course of this operation, the flux of injected gas entrains the solvent in which the coating is dissolved, which has the effect of increasing the concentration thereof beyond saturation, which provokes its precipitation on the particles. In this way, microcapsules are obtained, whose core is constituted by a particle which is totally coated by the coating product, these microcapsules being dispersed within the solution of the coating product.

The microparticles are then recovered by separating them from the liquid phase by passage through the filtering element 32. When the quantity of microcapsules fixed on this filtering element 32 is sufficient, the stream coming from the capturing and encapsulation chamber 25 is interrupted. The small quantities of the solvent present in the microcapsules may be eliminated by percolating, through the bed of these microcapsules deposited on the filtering element 32, a stream of carbon dioxide at supercritical pressure, by opening the valve 38 of the pipe 36. After total elimination of this solvent, the collecting recipient 30 is depressurized and the microcapsules recovered on the filtering element 32.

In the embodiment of the invention shown in FIG. 2, the capturing and encapsulation chamber 25 may be alternately placed in communication with two collecting recipients 30 and 30′ by control valves 42, 42′. Such an embodiment allows continuous operation, concerning the production, capturing and coating of the particles. Concerning their collection on the filters 32 and 32′, this collection may be effected on one of the filtering elements while the other will be connected to the chamber 25 and will be laden with particles.

The fluid leaving the capturing and encapsulating chamber 25 is then partially expanded to the recycling pressure through a valve 26 and heated, in the cyclonic separators 33, the collected solvent being drawn off in liquid phase at atmospheric pressure through the lock chambers 35, in accordance with a method described in French Patent FR-A-2 584 618 already cited.

The fluid, from which the major part of the solvent has been removed, is recycled after possible purification on the adsorbent bed 37 generally constituted by active charcoal, by liquefaction in the condenser 39 towards the liquid fluid reservoir 13, or partially rejected to the atmosphere through a valve 24. The addition of fluid in the liquid or gaseous state is effected via an inlet 20.

More precisely, in the Examples described hereinafter, the installation used is of a semi-industrial size. It was employed, using carbon dioxide as fluid at supercritical pressure, with a service pressure of 30 MPa and a temperature range going from 0° C. to 150° C. The diaphragm pump 15 allowed a flowrate of 6 kg/hr. to 20 kg/hr. of carbon dioxide at 30 MPa, the solution pump 9 allowed a flowrate of 0.05 kg/hr to 0.75 kg/hr. of liquid at 30 MPa, the fluid reservoir 13 having a total volume of 4 litres, the atomisation chamber 1 being constituted by a recipient terminated by a conical bottom with an angle of 45° and a diameter of 0.10 m and a total volume of 8 liters, the capturing and encapsulation chamber 25 being constituted by a recipient with a volume of 4.3 litres provided with an anchor-shaped stirrer driven by an electric motor at a speed varying between 100 and 800 revs per minute thanks to a magnetic drive, the collecting recipient 30 having a volume of 2 litres for a diameter of 0.10 m, and being provided over its section, at mid-height, with a filtering element 32 constituted by a membrane of non-woven glass microfibers with a porosity of 1.3 μm supported by a disc of sintered metal with a porosity of 50 μm.

### EXAMPLE 1

By means of the installation thus described, eight batches of very fine particles of amoxicilline were generated in accordance with the anti-solvent method, by pulverisation of a solution of 5% by mass of amoxicilline in N-methylpyrrolidone with a flowrate of 0.5 kg/hr. in a stream of 15 kg/hr. of carbon dioxide at 15 MPa and 40° C. This particle-laden fluid was expanded to a pressure of 5.5 MPa and was percolated within a solution of ethylcellulose in ethyl acetate containing 4.5% of this coating agent. After 15 minutes of percolation, the generation of particles and the stream of fluid at supercritical pressure were stopped, and the liquid phase having captured the particles was sent towards the collecting recipient 30, and passed through the filtering element 32. Once the emptying of the capturing and encapsulation chamber 25 was terminated, a stream of carbon dioxide at 15 MPa and 40° C. was percolated through the pipe 36, thereafter sending it, through pipe 40, towards the separators 33 where the organic solvents extracted were recovered. After depressurization of the recipient 30, the microcapsules fixed on the filtering element 32 were recovered.

Each batch, corresponding to 15 minutes of formation of the particles, was then recovered separately. The characteristics of the microcapsules which were obtained were the following:

Granulometric distribution: 90% of the microcapsules have a diameter included between 2.5 μm and 12.5 μm and a mean diameter of 8 μm,

Mean composition by mass: 65% of amoxicilline and 35% of ethylcellulose,

Mean yield of encapsulation of the amoxicilline: 78%.

An excellent reproducibity of the characteristics of each of the eight successive batches of microcapsules obtained, is observed. The organic solvent content of the microcapsules, determined by gaseous phase chromatography of the aqueous phase obtained by prolonged stirring under ultrasounds of the powder, remained less than 100 ppm for all the batches, which demonstrates the efficiency of the stripping of the organic solvents used and therefore allows these microcapsules to be used without subsequent treatment.

### EXAMPLE 2

The installation is virtually identical to that used in the preceding Example, except that the capturing and encapsulation chamber 25 may be connected alternately to two identical collecting recipients 30 and 30′ in accordance with the embodiment shown in FIG. 2. This makes it possible for the generation, capturing and encapsulation of particles to operate continuously, the collection taking place alternately on one or the other of the filters 32 and 32′. The experiments carried out under initial conditions identical to those described in the preceding Example showed that the results obtained are similar to those described previously.

1. Method for capturing and encapsulating with a coating agent particles dispersed in a fluid at supercritical pressure, characterized in that it comprises the steps consisting in:
expanding this fluid at a pressure less than its critical pressures, so as to bring it to a gaseous state;
causing said gas to percolate in a liquid consisting of a solution substantially saturated with the coating agent in a solvent in which the particles are insoluble, so as to extract at least partially the solvent, and causing the coating agent to precipitate onto the particles thereby forming microcapsules.

2. Method according to claim 1, characterized in that the concentration of the coating agent in the solvent is preferably sufficient in order that, due to the percolation of the gas in said liquid, the coating agent passes into oversaturation and consequently precipitates on the particles to coat them, such concentration nonetheless being sufficiently low to avoid a precipitation giving rise to the formation of agglomerates.

3. Method according to claim 2, characterized in that the microcapsules, dispersed within the solution of the coating agent, are subsequently separated therefrom by filtration.

4. Method according to one of the preceding claims, characterized in that the solution of coating agent is supplied continuously and there is continuously drawn off, through a filtering material (32) disposed in
a collecting recipient (30) under pressure, the quantity of liquid phase present in the chamber (25) being maintained virtually constant until the end of the operation for capturing and encapsulation of the particles, the microcapsules being subsequently recovered after elimination of the residual solvent absorbed thereby, by sweeping by a stream of pure fluid at supercritical pressure and depressurization of the collecting recipient (30).

5. Method according to any one of the preceding claims, characterized in that the encapsulated particles have a diameter included between 0.01 μm and 20 μm.

6. Method according to any one of the preceding claims, characterized in that the encapsulated particles are constituted by an active principle of food, pharmaceutical, cosmetic, agrochemical or veterinary interest.

7. Method according to any one of the preceding claims, characterized in that the fluid at supercritical pressure is carbon dioxide.

8. Method according to claim 7, characterized in that a coating agent in solution in water, whose solubility therein depends on the pH of the solution, is used.

9. Installation for capturing and coating fine particles in dispersion within a fluid in the supercritical state, characterized in that it comprises:
means for expanding the fluid in the supercritical state to take it to the state of gas,
a chamber (25) for capturing the particles containing a coating agent in solution in a solvent in which the particles are insoluble,
means for causing said gas to percolate through the solution.

10. Installation according to claim 9, characterized in that the concentration of the coating agent in the solvent is sufficient in order that, due to the percolation of the gas in said liquid, the coating agent passes into oversaturation and, consequently, precipitates on the particles to coat them, this concentration being nonetheless sufficiently low to avoid a precipitation giving rise to the formation of agglomerates.

11. Installation according to one of claims 9 or 10, characterized in that it comprise at least one collecting recipient (30) provided with filtering means (32), which is in communication with the capturing chamber (25).

12. Installation according to claim 11, characterized in that the collecting recipient (30) is in communication with means for supply of fluid at supercritical pressure (19, 36).

13. Installation according to one of claims 11 or 12, characterized in that it comprises two collecting recipients (30, 30′) which comprise means adapted to connect them in turn to the capturing chamber (25).
containing a coating agent in solution in a solvent in which the particles are insoluble,
means for causing said gas to percolate through the solution.

10. Installation according to one of claim 9, characterized in that it comprise at least one collecting recipient (30) provided with filtering means (32), which is in communication with the capturing chamber (25).

11. Installation according to claim 10, characterized in that the collecting recipient (30) is in communication with means for supply of fluid at supercritical pressure (19, 36).

12. Installation according to one of claims 10 or 11, characterized in that it comprises two collecting recipients (30, 30′) which comprise means adapted to connect them in turn to the capturing chamber (25).
